(19) United States
(12) Patent Application Publication
(10) Pub. No.: US 2009/0235966 A1
(43) Pub. Date: Sep. 24, 2009

(54) ERGONOMIC CRUTCHES

(76) Inventor: Bernardo Birnbaum, Miami, FL (US)

Correspondence Address: SANCHELIMA & ASSOCIATES, P.A.;JESUS SANCHELIMA, ESQ., 235 S.W. LE JEUNE ROAD, MIAMI, FL, 33134, US

(21) Appl. No.: 12/054,346

(22) Filed: Mar. 24, 2008

(51) Int. Cl. A61H 3/02

(52) U.S. Cl. 135/66

(57) ABSTRACT

A forearm crutch with a telescopic leg that includes a shoe assembly at the distal end with convex surfaces for the forward and rear portions to maximize contact area upon making contact with a supporting horizontal surface and as the load transmission ends. The other end of the leg is rigidly mounted to a housing that receives a pivotally mounted handle assembly with a locking mechanism for settling the former at a predetermined angular disposition over a given angular range. An adjustable forearm support assembly is mounted to the housing, opposite to where the leg is mounted. The crutch includes battery operated light and horn circuits that can be readily actuated by a user.

### OTHER RELATED APPLICATIONS

The present application is a continuation-in-part of pending U.S. patent application Ser. No. 11/531,953, for Ergonomic Crutches filed on Sep. 14, 2006, currently allowed which is hereby incorporated by reference.

### BACKGROUND OF THE INVENTION

1. Field of the Invention

The present invention relates to ergonomic crutches, and more particularly, to mobility assistance devices that are ergonomically designed and transmit a user's load with minimal abrupt changes.

2. Description of the Related Art

Several designs for crutches have been designed in the past. None of them, however, includes the ergonomic features claimed in the present application, specifically those that minimize abrupt transfers of a user's load through his/her affected body members (hand, arm, forearm) to the crutch assembly. Additionally, these features also provide lateral stability and at rest comfort.

Many crutch users complain about the difficulties, and some trauma, experienced with their crutches. These devices are intended to shift the user's weight load from their legs and feet to other parts of their bodies that usually do not bear these loads. As a user walks, moves, or even stays stationary, the transfer of this weight load is relatively abrupt. Thus, there is a need for crutches that slowly transfer the weight load of the user's body to minimize the abruptness of these transfers.

The parent application provides for features that permit a user to sit down using cooperatively designed handles and discloses other features that have been improved in the present application. One of these features relate to the articulated mechanism used for the handles that are capable of withstanding considerable larger loads than in the parent application, now allowed. The improvements claimed in the present application optimize the use of the ergonometrically compatible crutches while minimizing discomfort.

Other patents describing the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide an ergonomically designed crutch that minimizes abrupt transfers of weight load, through the user/crutch combination.

It is another object of this invention to provide such a crutch that can be adjusted to a user's physical needs and its features selectively enabled.

It is still another object of this invention to provide a crutch with lateral stability.

It is still another object of the present invention to provide a lightweight crutch.

It is yet another object of this invention to provide such a crutch that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents an isometric view of the present invention.

FIG. 2 represents an isometric view of the crutch shown in FIG. 1 from a different angle.

FIG. 3 illustrates an elevational view of the upper portion of the crutch shown in the previous figures with a partial cross-section of the angular adjustment mechanism for the handle assembly.

FIG. 3A is an enlarged isometric view of one half of the handle assembly housing.

FIG. 4 is an enlarged cross-sectional view of the adjustable handle assembly.

FIG. 4A schematically illustrates the handle shock absorber assembly including the backbone leaf spring mechanism and resilient cushion member with an arrow showing the application of the load.

FIG. 4B is an enlarged partial cross-sectional view of the locking mechanism.

FIG. 5 is an enlarged side view of the cuff member with pivotally mounted armband.

FIG. 6 is an enlarged isometric view of one of the preferred embodiments of the crutch shoe.

FIG. 7 is an elevational cross-section of the crutch's lowermost portion of the leg with shoe, showing the internal shock absorbing assembly.

### DETAILED DESCRIPTION OF THE PREFERRED EMBODIMENT

Referring now to the drawings, where the present invention is generally referred to with numeral 10, it can be observed that it basically includes extendable leg assembly 20, handle assembly 40, extendable cuff assembly 60, knee rest assembly 80, and shoe assembly 100.

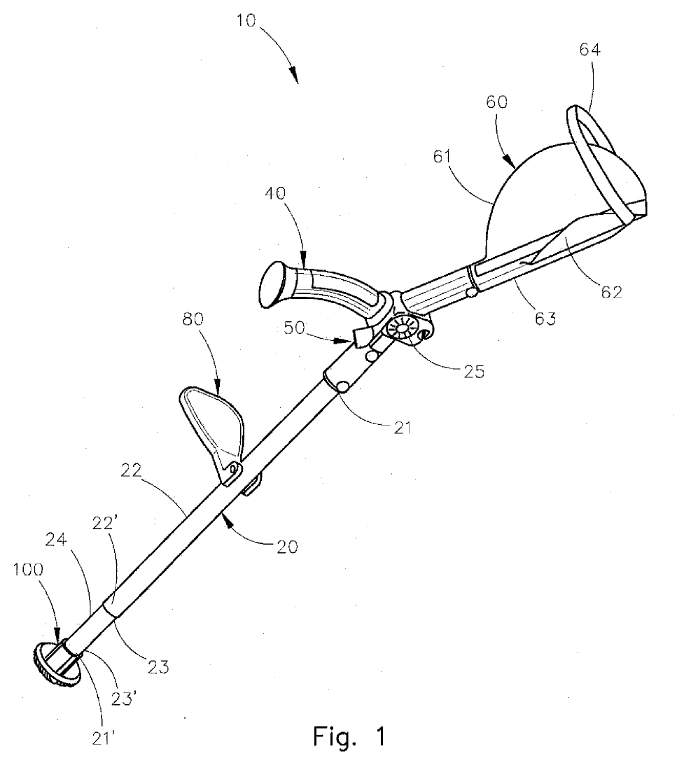

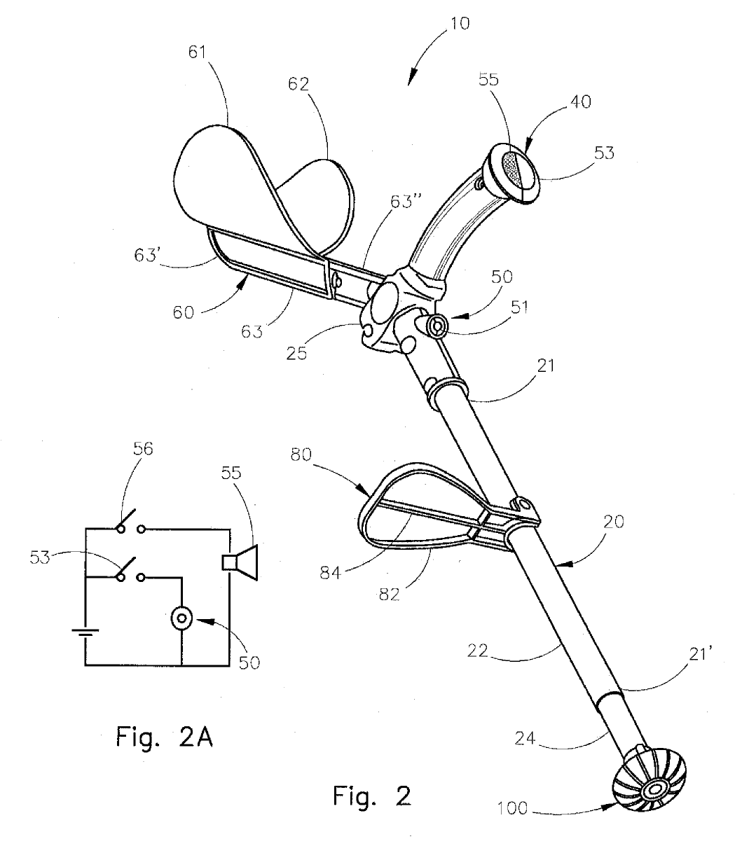

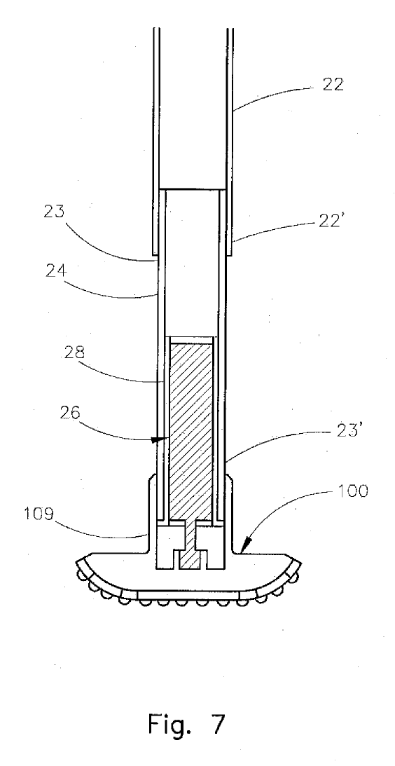

As shown in FIGS. 1 and 2, telescopic or extendable leg assembly 20, having ends 21 and 21′, includes tubular member 22 coaxially and telescopically housing tubular member 24 therein. Shock absorbing assembly 26, as best seen in FIG. 7, is housed within shock sleeve 28 and inserted within member 24. End 23 of member 24 is adjustably mounted within end 22′ of member 22. Shoe assembly 100 is mounted to end 23′ of member 24. Handle assembly 40 is mounted at end 21 of assembly 20.

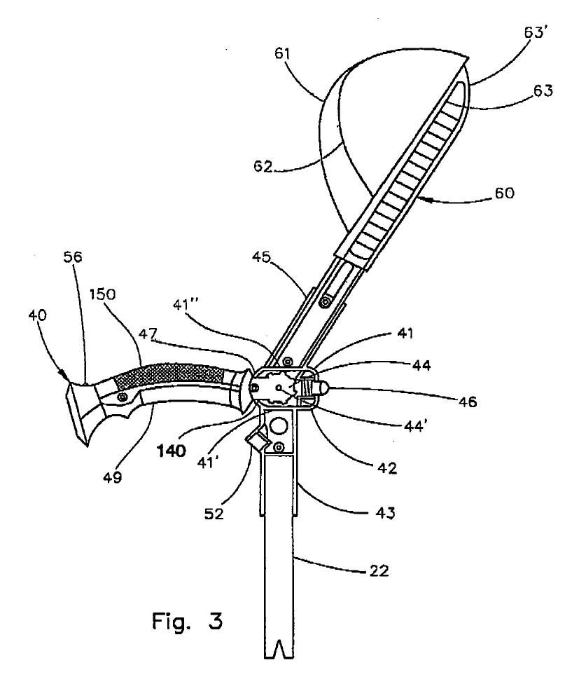

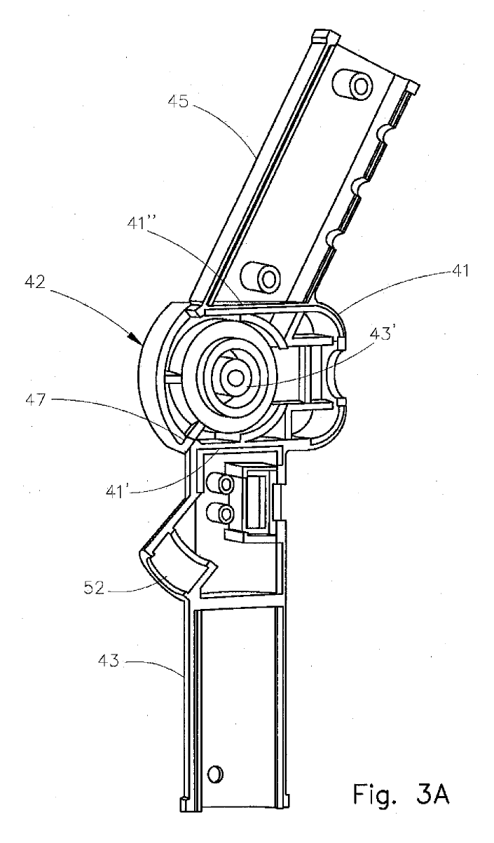

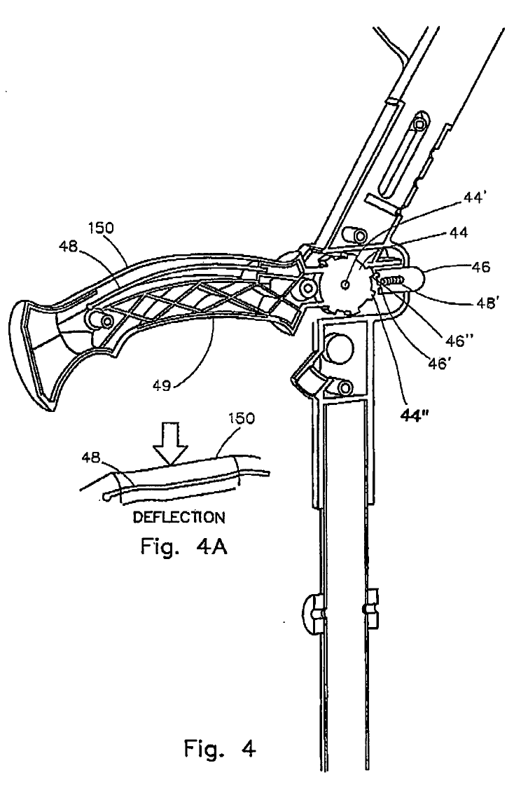

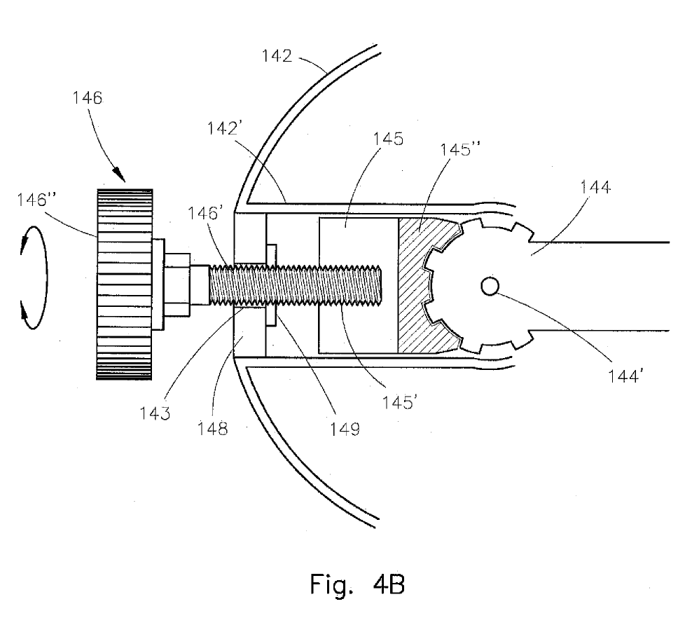

As seen in FIGS. 3 and 4, handle assembly 40 includes housing 42 with a central portion 41 and side portions 41′ and 41″. Tubular member 43 extends from side 41′ and inclined tubular member 45 extends from opposite side 41″. Opening 47 in housing 42 is opposite to central portion 41 and permits shank 44″ to move angularly between two extreme positions about a pivot point 44′ centrally located on teethed wheel section 44 mounted to the end of shank 44″. Wheel section 44 includes central through opening 44′ through which headed pin 25 passes and is held in place with rivets or nuts, as shown in FIGS. 1 and 2.

As best seen in FIG. 3A, bushing 43′ is designed to receive therethrough the shank of head pin 25 which also goes through opening 144′ of wheel section 144.

Locking member 46 includes a block member 46′ at one end with teeth 46″ that cooperatively engage with mating teeth 44″ of wheel section 44 to keep the latter in place and thus handle member 49, as best seen in FIG. 4. Spring 48′ urges block member 46′ against mating teeth 44″. Another embodiment for locking member 46 is shown as 146 in FIG. 4B, which includes a knurled knob 146, in this embodiment. A threaded shank 146′ passes through opening 143 in cover 148 which in turn is mounted to housing 142. Shank 146′ is inserted inside block 145 that includes central threaded opening 145′. Retainer collar 149 keeps shank 146′ in place. Central threaded opening 145′ cooperatively mates with threaded shank 146′. Upon rotation of shank 146′, block 145 advances between two extreme positions inside tubular member 142′ of housing 142. Block 145 has, at its end, a teethed arch member 145″ that mates with wheel section 144. In one of the extreme positions that block 145 travels to, arch member 145″ is disengaged from wheel section 144 permitting a user to adjust the angular position of handle assembly 40 to the user's preferences, at the other extreme position, teethed arched member 145″ matingly and lockingly engages with the teeth of wheel section 144. For better performances, wheel section 144 and teethed arched member 145″ are made out of a strong metal, such as steel or equivalent.

Leaf spring 48 is mounted relatively close to the upper side of member 49. Spring 48 is positioned to permit a predetermined degree of deflection upon the application of force through cushion 150 which is made out of a resilient material. Handle member 49 and leaf spring 48 are covered with high performance gel grip with an overall effect to dampen sudden load transmissions through a user's palms. This minimizes trauma to a user's hands and wrist by reducing abrupt changes of the bearing load.

Light assembly 50 is cooperatively mounted below handle assembly 40 to direct the light from lighting element 51 (LED or light bulb or equivalent) housed within light assembly compartment 52. Light switch 53 is conveniently mounted at the end of handle member 49, as best seen in FIG. 2. A sound generating assembly 55 is housed within handle member 49, at its distal end, as best seen in FIG. 2.

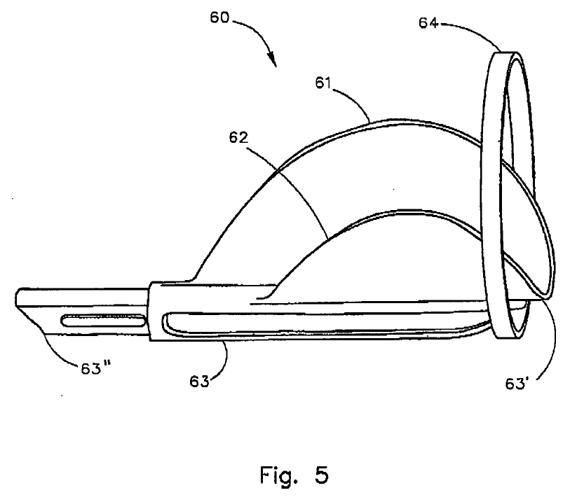

Cuff assembly 60, as shown in FIG. 5, includes cuff member 61 that cooperatively and ergonomically receives a user's forearm. An extendable rigid guide member 63 supports cuff member 61 to permit a user to change its relative position. Cuffs 61 and 62 provide lateral support to stabilize the use of crutch 10. Strap loop 64 is pivotally mounted to either guide member 63 or cuffs 61 and 62 adjacent to end 63″ and it has cooperative dimensions to permit a user to pass his/her forearm through. Loop 64 permits a user to free up his/her hands while still keeping crutch 10 within reach hanging from his/her forearm. End 63′ of guide member 63 is mounted within member 45.

Knee rest assembly 80 is pivotally mounted to tubular member 22 at a predetermined desired distance from the either end. Assembly 80 includes platform member 82 that is pivotally mounted, at one end, to member 22. The other end provides sufficient resting area for a user to lean against with his knee. Reinforcement member 84 runs along the underside of platform member 82.

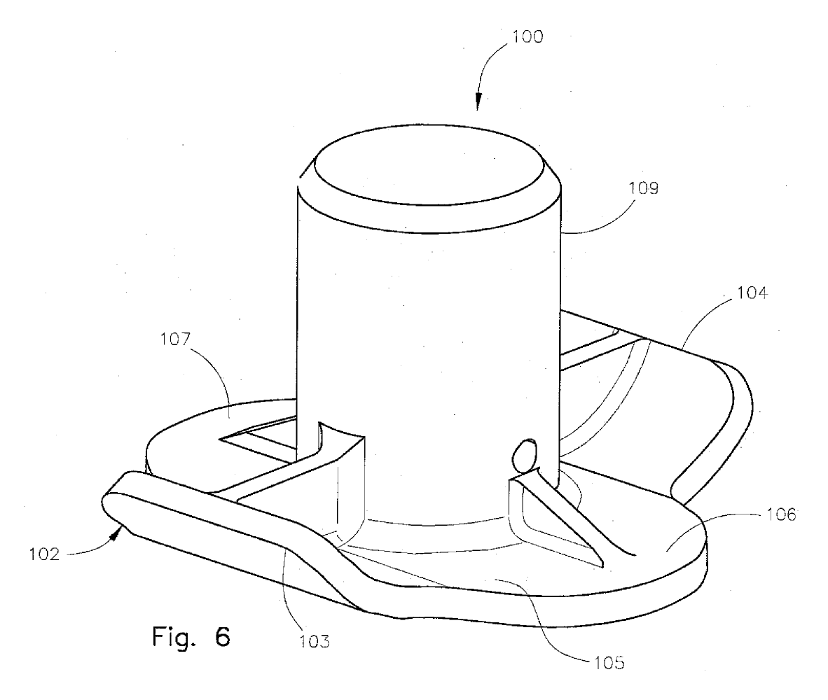

Shoe assembly 100, as shown in FIGS. 6 and 7, is mounted to the distal end of tubular member 24 through shock absorbing assembly 26. In one of the preferred embodiments, shoe assembly 100 includes bottom wall 102 that permits an engagement with the supporting surface on the crutch approach, while on it and as exiting the engagement surface. Bottom wall 102 has arched forward and rear ends 103 and 104 with a substantially flat portion 105 in between. Extending laterally from flat portion 105 are lateral flanges 106 and 107 that provide lateral stability to shoe assembly 100. From the upperside of portion 105 extends cylindrical member 109 a sufficient distance to receive the distal end of tubular member 24.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

1. A forearm crutch, comprising:
A) extendable leg means having first and second ends;
B) housing means rigidly mounted to said first end, said housing means including a space therein with first and second opposite through openings connecting said space;
C) forearm support means mounted to said housing means opposite to where said first end is mounted;
D) handle means having third and fourth ends, said third end being pivotally mounted through said first through opening to said housing means at a point within said space, said handle means further including means for selectively locking said handle means at an angular position within a predetermined angular range, and said means for selectively locking said handle means being actuated through said second through opening; and
E) shoe means mounted to said second end, said shoe means including a central flat portion defining a plane with curved forward and rear portion longitudinally extending from said flat portion providing a convex surface that is brought in contact with a horizontal surface over which said crutch is used before and after said flat portion is used to transmit the load transmitted by a user through said shoe means.

2. The crutch set forth in claim 1 wherein said second end includes firs shock absorber means so that abrupt load transmissions are minimized.

3. The crutch set forth in claim 2 wherein said first shock absorber means is selectively enabled by a user.

4. The crutch set forth in claim 3 wherein said central flat portion extends transversally a predetermined area to enhance lateral stability of the crutch.

5. The crutch set forth in claim 4 wherein said means for selectively locking said handle means includes an elongated locking member with a teethed block and said third end including mating teeth that cooperatively engage with said teethed block so that said handle means is kept at a predetermined angular position.

6. The crutch set forth in claim 5 wherein said teethed block includes a central threaded opening and said means for selectively locking said handle means include a threaded shank that matingly advances through said central threaded opening between two extreme positions thereby causing said teethed block to move towards and away from said mating teeth.

7. The crutch set forth in claim 6 wherein said shank includes a distal end with a knurled knob mounted thereon.

8. The crutch set forth in claim 7 wherein said housing means includes light means for illumination of the area surrounding said cutch, said light means being selectively activated.

9. The crutch set forth in claim 8 further including audible means for selectively generating sound.
